(19) United States
(12) Patent Application Publication
(10) Pub. No.: US 2017/0104382 A1
(43) Pub. Date: Apr. 13, 2017

(54) ELECTRIC POWER CONVERTER FOR ELECTROMOTIVE VEHICLE

(71) Applicant: TOYOTA JIDOSHA KABUSHIKI KAISHA, Toyota-shi, Aichi-ken (JP)

(72) Inventors: Masaya KAJI, Toyota-shi, Aichi-ken (JP); Ryusuke BABA, Toyota-shi, Aichi-ken (JP)

(73) Assignee: TOYOTA JIDOSHA KABUSHIKI KAISHA, Toyota-shi, Aichi-ken (JP)

(21) Appl. No.: 15/314,217

(22) PCT Filed: May 29, 2015
(86) PCT No.: PCT/IB2015/000779

§ 371 Date: Nov. 28, 2016

(30) Foreign Application Priority Data
May 30, 2014 (JP) 2014-112674

(51) Int. Cl. H02K 5/04; H02K 11/00; H02K 11/33; B60L 3/00; B60K 6/44

(52) U.S. Cl. CPC H02K 5/04; B60L 3/0007; B60L 3/0061; B60K 6/44; H02K 11/33; H02K 11/0094

(57) ABSTRACT

An electric power converter (10) is divided into a main casing (10a) and an auxiliary casing (10b). The main casing (10a) contains a high-voltage circuit (28, 29) through which electric power for driving a motor (83) flows. The auxiliary casing (10b) contains a control circuit (19) configured to control the high-voltage circuit. The auxiliary casing (10b) is connected to the main casing (10a) by a cable (23). The main casing (10a) and the auxiliary casing (10b) are accommodated in a front compartment (2) of a vehicle together with a motor case (3) that accommodates the motor. The main casing (10a) is fixedly mounted on the motor case (3). The auxiliary casing (10b) is arranged so as to be adjacent to the main casing (10a) and is fixed to a body of the vehicle.

### BACKGROUND OF THE INVENTION

1. Field of the Invention

The invention relates to an electric power converter that converts electric power of a battery to supply the converted electric power to a drive motor. An “electromotive vehicle” in the specification includes a hybrid vehicle and an electric vehicle. The hybrid vehicle includes both a motor and an engine. The electric vehicle includes a motor but the electric vehicle does not include an engine. A fuel cell vehicle is also included in the electromotive vehicle described in the specification.

2. Description of Related Art

An intended vehicle of the technique described in the specification includes a drive motor in a front compartment. The front compartment is a space located in front of a passenger compartment. In the following description, for the sake of convenience of description, “front”, “rear” and “lateral” respectively mean the front side of the vehicle, the rear side of the vehicle and the lateral direction of the vehicle. In the following description, the “drive motor” may be simply referred to as “motor”.

An electric power converter that supplies electric power to the motor should be arranged near the motor. This is because an electric power loss decreases as a power cable that connects the motor with the electric power converter becomes shorter. Therefore, the electric power converter is also mounted in the front compartment.

On the other hand, the electric power converter includes a circuit through which electric power for driving the motor flows. Such a circuit is supplied with a high voltage of a battery, so such a circuit is referred to as high-voltage circuit in the specification. A typical example of the high-voltage circuit is an inverter circuit including power transistors. On the other hand, the electric power converter also includes a circuit that is driven at a voltage that is by far lower than the above-described voltage of the battery. A typical example of such a circuit is a circuit that controls the high-voltage circuit. A control circuit that controls the high-voltage circuit is a circuit that outputs a signal having a TTL level or a voltage level close to the TTL level. Such a circuit is referred to as low-voltage circuit in the following description. The low-voltage circuit is supplied with electric power from a low-voltage battery different from the battery that stores electric power to be supplied to the motor. Hereinafter, for the purpose of distinguishing the two batteries from each other, the battery that stores electric power for driving the drive motor may be referred to as main battery, and the battery that stores electric power that has a lower output voltage than the main battery and that drives a so-called auxiliary, such as a low-voltage circuit and an interior light, may be referred to as auxiliary battery (sub-battery).

At the time of a collision of a vehicle with some kind of obstacle, it is undesirable that a high-voltage circuit become exposed as a result of breakage of the casing of an electric power converter. For this reason, techniques for improving the collision safety of an electric power converter are described in, for example, Japanese Patent Application Publication No. 2013-209078 (JP 2013-209078 A) and Japanese Patent Application Publication No. 2009-137404 (JP 2009-137404 A). In the technique described in JP 2013-209078 A, an electric power converter is arranged in front of a partition wall that separates a front compartment and a passenger compartment from each other. Inside the casing of the electric power converter, a high-voltage circuit is arranged on the front side, and a low-voltage circuit is arranged on the rear side. At the time of a collision of a vehicle, this electric power converter makes the high-voltage circuit difficult to become exposed even when the electric power converter hits the partition wall and, as a result, the rear portion of the electric power converter breaks.

In the technique described in JP 2009-137404 A, an electric power converter is installed on a motor case that accommodates a motor. Inside the casing of the electric power converter, a high-voltage circuit is arranged on the rear side, and a low-voltage circuit is arranged on the front side. A cooling plate is arranged between the high-voltage circuit and the low-voltage circuit. The cooling plate reinforces the casing in front of the high-voltage circuit. At the time of a collision of a vehicle, the low-voltage circuit serves a buffer to protect the high-voltage circuit.

### SUMMARY OF THE INVENTION

The technique described in JP 2013-209078 A and the technique described in JP 2009-137404 A devise the arrangement of the high-voltage circuit and the low-voltage circuit inside the casing of the electric power converter, thus preventing exposure of the high-voltage circuit at the time of a collision. The invention provides a technique for improving the collision safety of an electric power converter with a structure different from the structure described in JP 2013-209078 A or the structure described in JP 2009-137404 A.

An aspect of the invention provides an electric power converter that contains a high-voltage circuit and a low-voltage circuit in separate casings. When the size of the high-voltage circuit and the size of the low-voltage circuit are the same as those of an existing one, the casing that excludes the low-voltage circuit and contains only the high-voltage circuit is smaller than the casing of the existing electric power converter. When the casing becomes smaller, the strength of the casing increasing by itself. Hereinafter, for the sake of convenience of description, the casing that contains the high-voltage circuit is referred to as main casing, and the casing that contains the low-voltage circuit is referred to as auxiliary casing. As described above, the high-voltage circuit is a circuit through which electric power for driving a motor flows, and the low-voltage circuit is a circuit configured to control the high-voltage circuit.

As described above, the electric power converter is desirably arranged near the motor. Fixing the electric power converter to a motor case is desirable because the electric power converter is brought close to the motor. Because the motor case has a high strength, it is suitable that the electric power converter is fixedly mounted on the motor case from the viewpoint of collision safety. At the time of a collision of a vehicle, an obstacle collides with the motor case in advance of the electric power converter, so impact that acts on the electric power converter is relieved.

As described above, the electric power converter according to the aspect of the invention is formed of two casings (the main casing and the auxiliary casing). In the electric power converter according to the aspect of the invention, the main casing that accommodates the high-voltage circuit is fixedly mounted on the motor case. On the other hand, the auxiliary casing that contains the low-voltage circuit is arranged so as to be adjacent to the main casing; however, the auxiliary casing is fixed to not the motor case but a body of the vehicle. As a result, the high-voltage circuit accommodated in the main casing is arranged near the motor, so an electric power loss of a power cable is suppressed. Because the size of the main casing is smaller than that of the casing of the existing electric power converter, the space between the outline of the motor case and the outline of the main casing increases when viewed from above. Therefore, impact force further decreases before an obstacle that has collided with the motor case in advance collides with the main casing.

If both the main casing and the auxiliary casing are fixedly mounted on the motor case, the main casing and the auxiliary casing move together at the time of a collision, so the main casing can be sandwiched between the auxiliary casing and another device. By fixing the auxiliary casing to not the motor case but the body, the main casing and the auxiliary casing tend to exhibit different behaviors at the time of a collision, so the possibility that the main casing is sandwiched is reduced. The motor case generates large vibrations. Fixing the auxiliary casing to the body is advantageous in contributing to a reduction in vibrations of the auxiliary casing.

The low-voltage circuit contained in the auxiliary casing is a circuit configured to control the high-voltage circuit contained in the main casing. Therefore, a high-frequency signal flows through a cable that connects the auxiliary casing to the main casing. Because the auxiliary casing is arranged so as to be adjacent to the main casing, the cable that connects the auxiliary casing to the main casing is allowed to be short. The short cable contributes to raising the reliability of transmission of a high-frequency signal.

The body to which the auxiliary casing is fixed includes both a steel sheet that forms a front compartment or passenger compartment of the vehicle and a frame that undertakes the structural strength of the vehicle body, such as side members. The auxiliary casing may be fixed to the body via a bracket or a tray.

For the purpose of increasing the flexibility of arrangement of the auxiliary casing in the front compartment, a substrate on which the low-voltage circuit is implemented may be contained in the auxiliary casing in an upright position. The upright position is a position in which a normal to a flat face of the substrate is directed in a horizontal direction. By containing the substrate in such a position, it is possible to reduce the size of the auxiliary casing in the horizontal direction. As a result, the flexibility of arrangement of the auxiliary casing increases.

The main casing and the auxiliary casing may be arranged side by side in a vehicle width direction, and a front end of the auxiliary casing may be located forward with respect to a front end of the main casing. With such arrangement, at the time of a collision of the vehicle with an obstacle ahead, the auxiliary casing collides with the obstacle in advance to protect the main casing.

The electric power converter according to the aspect of the invention is suitable for application to a hybrid vehicle including an engine for propelling the vehicle together with the motor. In such a case, the engine may be arranged so as to be adjacent to the motor case in a vehicle width direction, and the auxiliary casing of the electric power converter may be arranged so as to be adjacent to the main casing on a side across from the engine. It is possible to suppress the influence of heat of the engine on the low-voltage circuit inside the auxiliary casing.

The details of the technique according to the aspect of the invention and further improvements will be described in an embodiment of the invention described below.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a block diagram of an electric power system of a hybrid vehicle including an electric power converter according to an embodiment;

FIG. 2A to FIG. 2C are views that show a device layout in a front compartment, in which FIG. 2A is a plan view of the front compartment, FIG. 2B is a front view of the front compartment, and FIG. 2C is a side view of the front compartment;

FIG. 3 is a schematic perspective view of a main casing and auxiliary casing of the electric power converter; and

FIG. 4 is a view that shows an alternative embodiment of a supporting structure for the auxiliary casing.

### DETAILED DESCRIPTION OF EMBODIMENTS

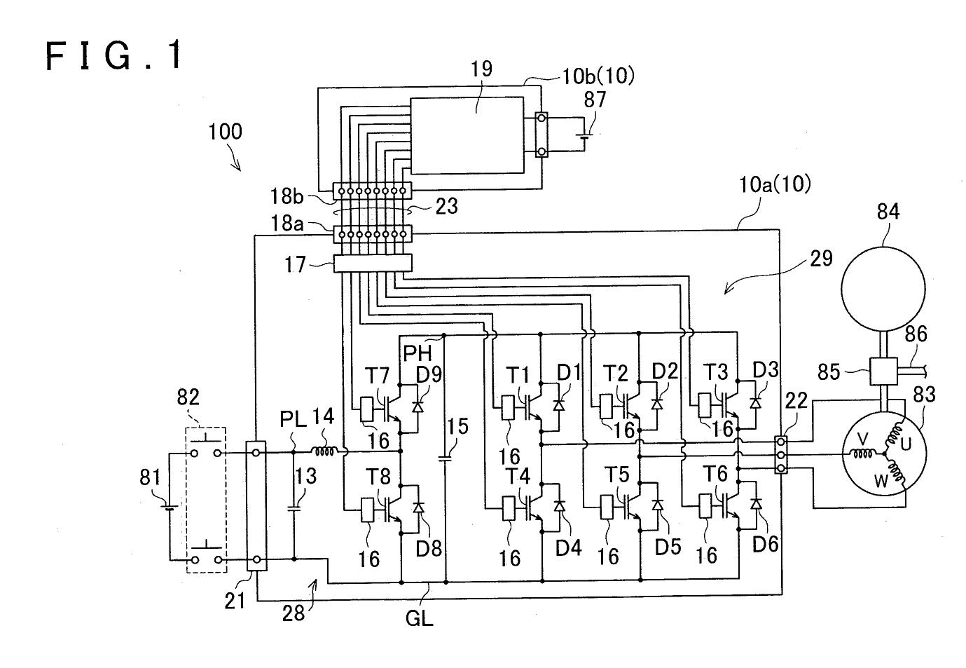

An embodiment of an electric power converter 10 will be described with reference to the accompanying drawings. The electric power converter 10 is mounted on a hybrid vehicle 100. Initially, an electric power system of the hybrid vehicle 100 will be described with reference to the block diagram of FIG. 1. The hybrid vehicle 100 includes a drive motor 83 and an engine 84. The output shaft of the motor 83 and the output shaft of the engine 84 are coupled to a power split mechanism 85. The power split mechanism 85 combines or allocates the output torque of the motor 83 and the output torque of the engine 84 as appropriate. The output torque of the motor 83 and the output torque of the engine 84 are combined at the power split mechanism 85 and transmitted to an axle 86. Alternatively, the output torque of the engine 84 is split by the power split mechanism 85, part of the output torque is transmitted to the axle 86, and the remaining part of the output torque is transmitted to the motor 83. At this time, the motor 83 generates electric power by using the output torque of the engine 84. A main battery 81 is charged with electric power obtained through electric power generation.

The electric power converter 10 will be described. The electric power converter 10 steps up the electric power of the main battery 81, converts the electric power into alternating-current power, and then supplies the alternating-current power to the drive motor 83. The electric power converter 10 is also able to convert electric power generated by the motor 83 (regenerated electric power) to direct-current power, step down the direct-current power, and supply the stepped-down direct-current power to the main battery 81. The electric power converter 10 is divided into two casings (a main casing 10a and an auxiliary casing 10b), which will be described later.

The circuit configuration of the electric power converter 10 will be described. The main battery 81 is connected to the electric power converter 10 via a system main relay 82. The reference numeral 21 denotes a connector for connection with a cable extending from the system main relay 82.

The main battery 81 stores electric power that is supplied to the drive motor 83. The electric power converter 10 includes a voltage converter circuit 28 and an inverter circuit 29. The electric power of the main battery 81 is input to the voltage converter circuit 28. The voltage converter circuit 28 is able to carry out both a step-up operation and a step-down operation. In the step-up operation, the voltage of the main battery 81 is stepped up, and electric power having the stepped-up voltage is supplied to the inverter circuit 29. In the step-down operation, the voltage of regenerated electric power generated by the motor 83 is stepped down, and the regenerated electric power having the stepped-down voltage is supplied to the main battery 81. The voltage converter circuit 28 includes two transistors T7, T8, two diodes D9, D8, a reactor 14, and a filter capacitor 13. The transistors T7, T8 are connected in series with each other. Each diode is connected in antiparallel with a corresponding one of the transistors. The high-potential end of a series circuit of the transistors is connected to an inverter-side output terminal PH of the voltage converter circuit 28. The low-potential end of the series circuit is connected to a ground line GL of the voltage converter circuit 28. One end of the reactor 14 is connected to the middle point of the series circuit of the transistors, and the other end is connected to a battery-side input terminal PL of the voltage converter circuit 28. The filter capacitor 13 is connected between the battery-side input terminal PL and ground line GL of the voltage converter circuit 28.

The voltage of the main battery 81 is stepped up through the on-off operation of the transistor T8, and electric power having the stepped-up voltage is supplied to the inverter circuit 29. Regenerated electric power that is input from the inverter circuit side is stepped down through the on-off operation of the transistor T7, and the regenerated electric power having the stepped-down voltage is supplied to the main battery 81. Driving signals (PWM signals) for driving the transistors T7, T8 are generated by a control circuit 19. The driving signals generated by the control circuit 19 are supplied to drivers 16 via a connector 18b, a cable 23, a connector 18a and an insulated signal transmission circuit 17. Each of the drivers 16 converts a TTL-level driving signal transmitted from the control circuit 19 to a driving signal having a level at which the gate of a corresponding one of the transistors is driven, and supplies the driving signal to a corresponding one of the transistors T7, T8.

The insulated signal transmission circuit 17 is a circuit that transmits a digital signal in an insulated state, and is, for example, a photocoupler. The insulated signal transmission circuit 17 may be a pulse transformer or a magnetic coupler instead of a photocoupler. The control circuit 19 operates on electric power that is supplied from an auxiliary battery 87. The auxiliary battery 87 stores electric power that is supplied to electronic devices other than the motor. The output voltage of the main battery 81 is higher than or equal to 100 volts, whereas the output voltage of the auxiliary battery 87 is lower than 100 volts. Typically, the output voltage of the auxiliary battery 87 is any one of 12 volts, 24 volts or 48 volts.

The inverter circuit 29 will be described. The inverter circuit 29 is a circuit in which three sets of series circuits each including two transistors are connected in parallel with one another (T1 and T4, T2 and T5, T3 and T6). A diode (D1 to D6) is connected in antiparallel with a corresponding one of the transistors. Alternating current is output from the middle point of each series circuit through the on-off operation of the corresponding transistors. The output alternating currents are supplied to the motor 83. The reference numeral 15 denotes a smoothing capacitor 15 for suppressing pulsation of current that is supplied to the inverter circuit 29. The reference numeral 22 denotes a connector for a power cable that supplies electric power to the motor 83.

Driving signals (PWM signals) for driving the transistors T1 to T8 are generated by the control circuit 19. The driving signals generated by the control circuit 19 are supplied to drivers 16 via the connector 18b, the cable 23, the connector 18a and the insulated signal transmission circuit 17. Each of the drivers 16 converts a TTL-level driving signal transmitted from the control circuit 19 to a driving signal having a level at which the gate of a corresponding one of the transistors is driven, and supplies the driving signal to the corresponding one of the transistors T1 to T8.

As described above, the electric power converter 10 is divided into the two casings (the main casing 10a and the auxiliary casing 10b). The circuits contained in the main casing 10a are the voltage converter circuit 28 and the inverter circuit 29. The voltage of electric power that is supplied from the main battery 81 is applied to the voltage converter circuit 28 and the inverter circuit 29. In other words, electric power for driving the motor 83 flows through the voltage converter circuit 28 and the inverter circuit 29. The voltage converter circuit 28 and the inverter circuit 29 to which the voltage of electric power that is supplied from the main battery 81 correspond to the above-described high-voltage circuit.

On the other hand, the control circuit 19 that controls the high-voltage circuit is contained in the auxiliary casing 10b. The control circuit 19 specifically generates the driving signals for driving the transistors T1 to T8 included in the high-voltage circuit. A typical example of the driving signals is a pulse width modulation (PWM) signal. The main components of the control circuit 19 are a semiconductor logic chip and a memory chip that operate at the TTL level that is by far lower than the output voltage of the main battery 81. Electric power for driving the control circuit 19 is supplied from the auxiliary battery 87. In other words, the control circuit 19 is the low-voltage circuit that operates at a voltage lower than the output voltage of the main battery 81. The high-voltage circuit (the voltage converter circuit 28 and the inverter circuit 29) and the control circuit 19 are connected to each other by the cable 23; however, the high-voltage circuit and the control circuit 19 are insulated from each other by the insulated signal transmission circuit 17.

The control circuit 19 and the high-voltage circuit are contained in separate casings. The control circuit 19 and the high-voltage circuit transmit digital driving signals via the cable 23. However, even with communication via the cable 23, no protocol accompanying communication handshake is used between the control circuit 19 and the high-voltage circuit (the drivers 16 for the transistors). The communication handshake is communication procedure for raising the reliability of data transmission at the time of communicating a digital signal between devices connected to both ends of a cable. In the electric power converter 10 according to the embodiment, the control circuit 19 and the high-voltage circuit (the drivers 16) transmit signals without communication handshake, and the driving signals output from the control circuit 19 are transmitted to the drivers 16 with only a time delay of the insulated signal transmission circuit 17. The frequency of each PWM signal is about 10 [kHz]. When communication handshake is employed, it is difficult to transmit such high-frequency digital signals without a time delay. Therefore, in the electric power converter 10 according to the embodiment, driving signals are transmitted between the high-voltage circuit and the control circuit 19 without any communication protocol on purpose.

Next, the structure in which the electric power converter 10 is mounted on the vehicle will be described. The electric power converter 10 is arranged near the motor 83 for the purpose of reducing a loss of the power cable. In the hybrid vehicle 100 according to the embodiment, the motor 83 and the engine 84 are mounted in a front compartment at the front of the vehicle. Therefore, the electric power converter 10 (the main casing 10a and the auxiliary casing 10b) is also mounted in the front compartment.

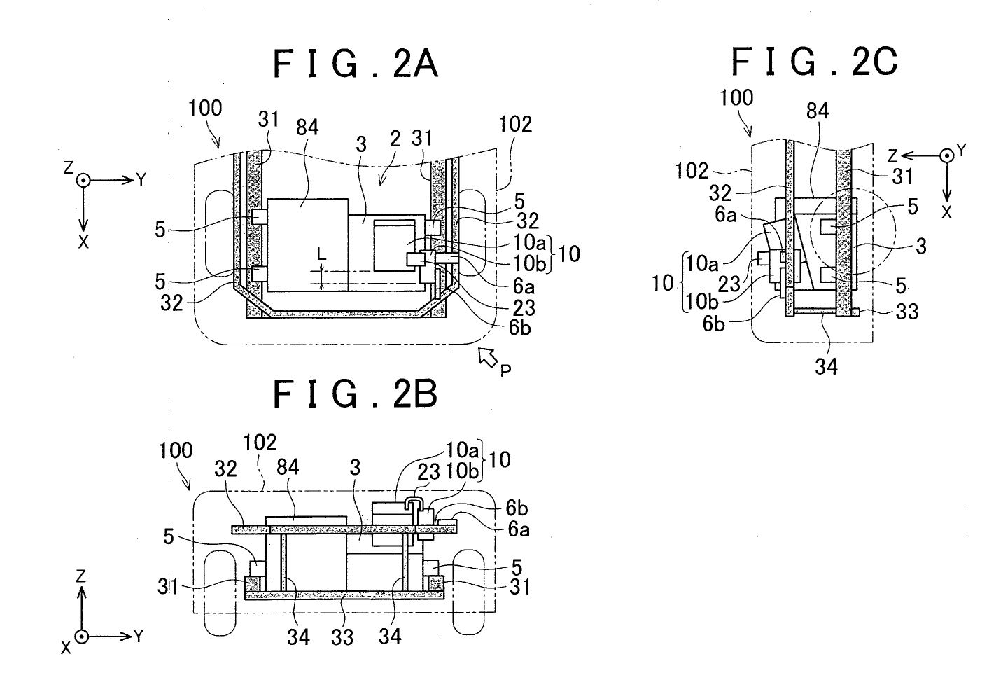

FIG. 2A to FIG. 2C show a devise layout in the front compartment. FIG. 2A is a plan view of the front compartment 2. FIG. 2B is a front view of the front compartment 2. FIG. 2C is a side view of the front compartment 2. The positive direction of the X-axis in the coordinate system in the drawings corresponds to the forward direction of the vehicle. The Y-axis direction in the drawings corresponds to a vehicle width direction (lateral direction). The positive direction of the Z-axis in the drawings corresponds to the upward direction in the vertical direction. Any one of the drawings indicates an outer shell 102 and tires of the vehicle by the alternate long and two-short dashed lines for the purpose of easy understanding of the inside of the front compartment 2. In the following description, the layout of the electric power converter 10 (the main casing 10a and the auxiliary casing 10b), the engine 84 and a motor case 3 will be described. Although other devices are mounted in the front compartment 2, those are not shown or described.

In FIG. 2A to FIG. 2C (and FIG. 4), for the sake of easy understanding, a member that corresponds to the body of the vehicle is filled in with gray (except the outer shell 102 drawn by the alternate long and two-short dashed line). In the specification, a steel sheet defining the front compartment or the passenger compartment (including the outer shell 102 of the vehicle) and a frame that ensures the strength of the vehicle body are collectively referred to as body. Two side members 31, a radiator support upper 32, a radiator support lower 33 and two radiator support sides 34 are included in the components of the body shown in the drawing. The side members 31 correspond to the frame. The two side members 31 are located at both sides in the vehicle width direction when the front compartment 2 is viewed from above. Each of the side members 31 extends in the longitudinal direction at the lower side of the vehicle.

The radiator support upper 32 extends between the two side members 31 at the upper front side of the vehicle, and is bent rearward of the vehicle at the front lateral sides of the vehicle. The radiator support lower 33 is connected to the two side members 31 at the lower front of the vehicle. The radiator support sides 34 extend in the up-and-down direction, and connect the radiator support upper 32 to the radiator support lower 33. Although not shown in the drawing, a radiator is arranged in the space surrounded by the radiator support upper 32, the radiator support lower 33 and the radiator support sides 34.

The devices having a larger size in the front compartment 2 are the engine 84 and the motor case 3. The motor case 3 contains the motor 83 and the power split mechanism 85 (see FIG. 1). The engine 84 and the motor 83 generate large vibrations, so the engine 84 and the motor 83 are suspended by the two side members 31 via an engine mount 5 that is a vibration-isolating device. The main casing 10a of the electric power converter 10 is fixedly mounted on the motor case 3, and, as shown in FIG. 2C, the top face of the motor case 3 is inclined forward, and the main casing 10a is fixedly mounted on the inclined top face of the motor case 3.

The auxiliary casing 10b of the electric power converter 10 is arranged so as to be adjacent to the main casing 10a in the vehicle width direction (the Y-axis direction in the drawing). The main casing 10a and the auxiliary casing 10b are connected to each other by the cable 23. Because the auxiliary casing 10b is arranged so as to be adjacent to the main casing 10a, the length of the cable 23 is allowed to be short. As will be described in detail later, the control circuit 19 transmits the driving signals (PWM signals) to the high-voltage circuit (the voltage converter circuit 28 and the inverter circuit 29). The frequency of each PWM signal is relatively high. The short cable 23 for transmission of signals between the control circuit 19 and the high-voltage circuit is advantageous in raising the reliability of transmission of high-frequency signals. However, the auxiliary casing 10b is not fixed to the motor case 3 or the main casing 10a. The auxiliary casing 10b is fixed to the radiator support upper 32 via two brackets 6a, 6b. That is, the auxiliary casing 10b is fixed to the member that constitutes the body.

The layout of the main casing 10a and auxiliary casing 10b shown in FIG. 2A to FIG. 2C provides a structure that, at the time of a collision of the vehicle with an obstacle ahead, the high-voltage circuit inside the main casing 10a is difficult to become exposed. This will be described below.

One of factors that contribute to preventing exposure of the high-voltage circuit is that the main casing 10a that contains the high-voltage circuit and the auxiliary casing 10b that contains the control circuit 19 are separated from each other. Another one of the factors is that the main casing 10a is fixedly mounted on the motor case 3 and the auxiliary casing 10b is fixed to the body. When viewed from above, the main casing 10a is fit inside the outline of the motor case 3. At the time of a collision of the vehicle with an obstacle ahead, the obstacle collides with the motor case 3 in advance of a collision with the main casing 10a. Therefore, the motor case 3 relieves the impact of a collision the main casing 10a receives. Because the electric power converter 10 contains the control circuit 19 in the auxiliary casing 10b, the size of the main casing 10a that contains the high-voltage circuit is smaller than the existing electric power converter in which a high-voltage circuit and a control circuit are contained together. As the size of the casing decreases, the strength of the casing increases, and the casing becomes more difficult to break at the time of a collision. In the following description, a collision of the vehicle with an obstacle ahead is referred to as frontal collision.

Moreover, the auxiliary casing 10b is fixed to not the motor case 3 but the body (the radiator support upper 32). If the auxiliary casing 10b is fixed to the motor case 3, the main casing 10a and the auxiliary casing 10b tend to move together at the time of a collision. As a result, the main casing 10a can be sandwiched between the auxiliary casing 10b and another device. When the main casing 10a further receives impact in that situation, there is a concern that the main casing 10a crushes. In contrast, when the auxiliary casing 10b is fixed to not the motor case 3 but the body, the motor case 3 and the body (the radiator support upper 32) exhibit different behaviors for the impact of a collision, so the auxiliary casing 10b exhibits a behavior different from that of the main casing 10a. Therefore, the main casing 10a can be less likely to be sandwiched between the auxiliary casing 10b and another device. The fact that the main casing 10a and the auxiliary casing 10b tend to exhibit different behaviors means that the main casing 10a is allowed to freely move without being limited by the movement of the auxiliary casing 10b.

Therefore, the main casing 10a is easy to move by fixing the auxiliary casing 10b to the body rather than fixing both the main casing 10a and the auxiliary casing 10b to the motor case 3. This also contributes to relieving impact that acts on the main casing 10a. The above layout makes the main casing 10a difficult to break, and reduces the possibility of exposure of the high-voltage circuit.

The above structure further has a point that contributes to preventing exposure of the high-voltage circuit. The point is that the front end of the auxiliary casing 10b is located forward by a distance L with respect to the front end of the main casing 10a. With this structure, at the time of a frontal collision, the auxiliary casing 10b also collides with an obstacle in advance of the main casing 10a. The auxiliary casing 10b also relieves the impact of a collision the main casing 10a receives. The auxiliary casing 10b is located outward of the vehicle with respect to the main casing 10a in the vehicle width direction. With this point and the point that the front end of the auxiliary casing 10b is located forward by the distance L with respect to the front end of the main casing 10a, at the time of a collision from the direction of the arrow P in FIG. 2A (oblique collision) as well, the auxiliary casing 10b serves as a buffer to protect the main casing 10a.

The high-voltage circuit (the voltage converter circuit 28 and the inverter circuit 29) contained in the main casing 10a and the low-voltage circuit (the control circuit 19) contained in the auxiliary casing 10b transmit digital signals via the insulated signal transmission circuit 17, so the high-voltage circuit and the low-voltage circuit are insulated from each other. Therefore, if the low-voltage circuit becomes exposed or breaks, current does not leak from the high-voltage circuit through the low-voltage circuit.

There is another advantage in the structure that the auxiliary casing 10b is fixed to the body. The motor 83 is contained in the motor case 3. The motor case 3 and the engine 84 are coupled to each other. The engine 84 and the motor 83 generate large vibrations. That is, the motor case 3 generates large vibrations. Because the auxiliary casing 10b is fixed to the body, the auxiliary casing 10b is difficult to receive the influence of the vibrations of the motor case 3.

The auxiliary casing 10b is arranged so as to be adjacent to the main casing 10a on the side across from the engine 84 in the vehicle width direction. The engine 84 is a large heat source. Because the main casing 10a is located between the auxiliary casing 10b and the engine 84, the auxiliary casing 10b is difficult to receive the influence of heat of the engine 84.

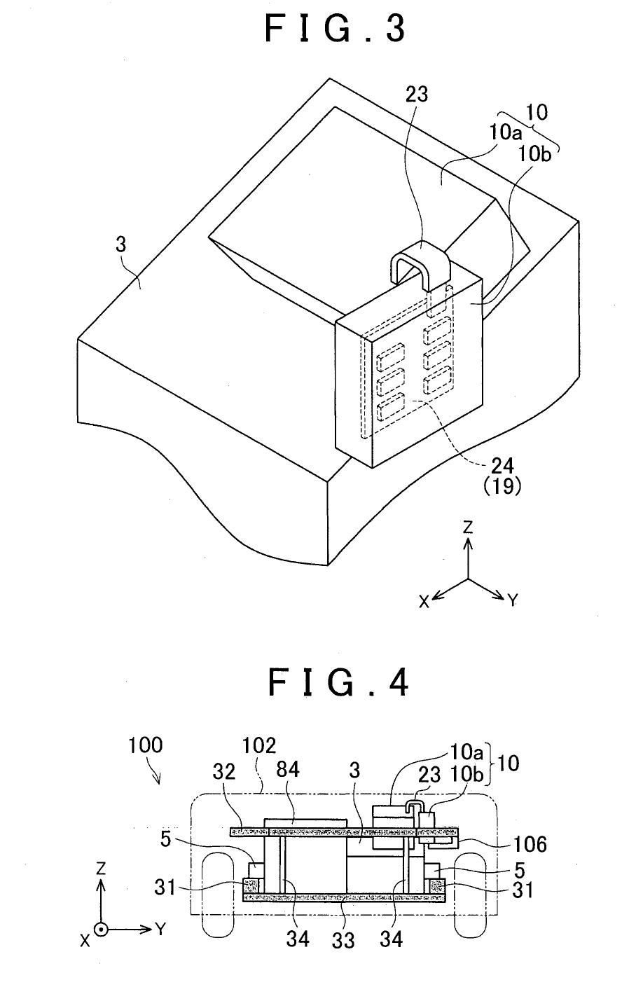

Next, FIG. 3 shows a schematic perspective view of the main casing 10a and the auxiliary casing 10b. In FIG. 3, a substrate 24 incorporated in the auxiliary casing 10b is also indicated by the dashed line. The substrate 24 is a piece of hardware on which the control circuit 19 is implemented. As shown in FIG. 3, the substrate 24 on which the control circuit 19 is implemented is contained in the auxiliary casing 10b in an upright position. Therefore, the area of the auxiliary casing 10b when viewed from above is small, and the flexibility of layout in the front compartment increases. The upright position is a position in which a normal to a flat face of the substrate is directed in a horizontal direction.

The electric power converter 10 formed of the two casings is described above. Points to remember, regarding the technique described in the embodiment, will be described. The main casing 10a that contains the high-voltage circuit is fixedly mounted on the motor case 3. The auxiliary casing 10b that contains the control circuit is fixed to the body. In the embodiment, the auxiliary casing 10b is fixed to the radiator support upper 32, which is part of the body, via the two brackets 6a, 6b. The two brackets 6a, 6b each support the side face of the auxiliary casing 10b. Instead, as shown in FIG. 4, the lower face of the auxiliary casing 10b is supported by a tray 106. The tray 106 is fixed to the radiator support upper 32.

The auxiliary casing 10b may be fixed to any component that constitutes the body, except the motor case 3 or the engine 84. The auxiliary casing 10b may be fixed to, for example, a suspension tower or may be fixed to another frame, for example, the side member 31.

In the electric power converter 10 according to the embodiment, the cable 23 is connected to the upper face of the main casing 10a and the upper face of the auxiliary casing 10b. The cable 23 may be connected to the rear face of the main casing 10a and the rear face of the auxiliary casing 10b.

A voltage slightly lower than the output voltage of the main battery can be applied to the high-voltage circuit. This is, for example, the case where a resistor is connected between the main battery and the high-voltage circuit. In such a case as well, the voltage of the electric power of the battery is definitely applied to the high-voltage circuit. That is, in such a case as well, the high-voltage circuit corresponds to the circuit through which electric power for driving the drive motor flows.

As described above, the high-voltage circuit converts the electric power of the battery to electric power suitable for driving the motor. A typical example of the high-voltage circuit is the inverter circuit. The inverter circuit includes power transistors and drivers for the power transistors. A typical example of the low-voltage circuit is the circuit that controls the high-voltage circuit. The low-voltage circuit transmits a TTL-level (or a voltage level close to the TTL level) driving signal for controlling a corresponding one of the power transistors to the corresponding one of the drivers. Generally, the voltage level at which the gate of each power transistor is driven is higher than the TTL level. Each driver is a circuit that converts the TTL-level driving signal to the gate driving signal of the corresponding one of the power transistors. On the other hand, generally, a communication protocol (communication handshake) called controller area network (CAN) is mostly employed in communication between in-vehicle controllers.

The band (communication speed) of the CAN at present ranges from 500 to 1000 [kbps]. There is a time delay of several milliseconds in communication accompanying communication handshake, such as the CAN. On the other hand, the carrier frequency of PWM signals in the electric power converter at present is about 10 [kHz]. Therefore, there is a concern that the band of the CAN at present is not sufficient for transmission of

PWM signals to the drivers. In this case, digital signals that the low-voltage circuit outputs should be transmitted to the drivers without communication handshake. The electric power converter 10 according to the embodiment transmits the PWM signals from the control circuit to the driver without communication handshake on purpose from the viewpoint of collision safety. As is best shown in FIG. 2A to FIG. 2C, the auxiliary casing 10b is arranged so as to be adjacent to the main casing 10a. Therefore, the cable 23 that connects the auxiliary casing 10b to the main casing 10a to transmit the digital signals is allowed to be short. When the digital signals are transmitted without communication handshake, the short cable 23 contributes to raising the reliability of transmission of signals.

The characteristic of the electric power converter 10 according to the embodiment from the viewpoint of no communication handshake is as follows. The high-voltage circuit (the voltage converter circuit 28 and the inverter circuit 29) includes the power transistors (T1 to T8) for converting electric power and the drivers 16 for the power transistors. The driving signals for driving the power transistors (T1 to T8) are transmitted from the control circuit 19 to the drivers 16 through the cable 23 without communication handshake.

An example embodiment of the invention is described in detail above; however, this is only illustrative. The example embodiment does not limit the scope of the appended claims. The technique described in the appended claims encompasses various modifications and alterations of the example embodiment illustrated above. The technical elements described in the specification or the drawings exercise technical utility solely or in various combinations, and are not limited to the combinations described in the appended claims at the time of filing the application. The technique illustrated in the specification or the drawings can achieve multiple purposes at the same time, and has technical utility by achieving at least one of the multiple purposes.

What is claimed is:

1. An electric power converter that converts electric power of a battery to supply the converted electric power to a drive motor, the electric power converter characterized by comprising:
a main casing containing a high-voltage circuit through which electric power for driving the motor flows, the main casing being fixedly mounted on a motor case that accommodates the motor, the main casing being accommodated in a front compartment of a vehicle; and
an auxiliary casing connected to the main casing by a cable, the auxiliary casing containing a low-voltage circuit that operates at a voltage lower than a voltage of the battery and that is configured to control the high-voltage circuit, the auxiliary casing being arranged so as to be adjacent to the main casing, the auxiliary casing being fixed to a body of the vehicle, the auxiliary casing being accommodated in the front compartment of the vehicle.

2. The electric power converter according to claim 1, wherein
a substrate on which the low-voltage circuit is implemented is contained in the auxiliary casing in an upright position.

3. The electric power converter according to claim 1, wherein
the upright position is a position in which a normal to a flat face of the substrate is directed in a horizontal direction.

4. The electric power converter according to claim 1, wherein
an engine is arranged so as to be adjacent to the motor case in a vehicle width direction, and the auxiliary casing is arranged so as to be adjacent to the main casing on a side across from the engine.

5. The electric power converter according to claim 1, wherein
the main casing and the auxiliary casing are arranged side by side in a vehicle width direction, and a front end of the auxiliary casing is located forward with respect to a front end of the main casing.

6. The electric power converter according to claim 1, wherein
the auxiliary casing is located outward of the vehicle with respect to the main casing in a vehicle width direction.

7. The electric power converter according to claim 1, wherein
the auxiliary casing is fixed to the body via a bracket or a tray.
